(19) United States
(12) Patent Application Publication
(10) Pub. No.: US 2022/0404837 A1
(43) Pub. Date: Dec. 22, 2022

(54) MOVING BODY CONTROL SYSTEM, MOVING BODY CONTROL APPARATUS, AND MOVING BODY CONTROL METHOD

(71) Applicant: NEC Corporation, Minato-ku, Tokyo (JP)

(72) Inventor: Takayuki SUZUKI, Tokyo (JP)

(73) Assignee: NEC Corporation, Minato-ku, Tokyo (JP)

(21) Appl. No.: 17/777,176

(22) PCT Filed: Nov. 20, 2019
(86) PCT No.: PCT/JP2019/045462

§ 371 Date: May 16, 2022

(51) Int. Cl. G05D 1/04; G05D 1/10; B64C 39/02; G01S 17/48

(52) U.S. Cl. CPC G05D 1/042; G05D 1/101; B64C 39/024; G01S 17/48; B64C 2201/127

(57) ABSTRACT

In order to continuously acquire positional information of a moving body without losing sight of a target provided to the moving body, a moving body control system 1 a includes a moving body 100a with a target 100a, a positional information transmission apparatus 200 transmitting positional information of the target 100a on the basis of tracking the target 100a, a collimation possibility determining unit 109 determining, on the basis of an inclination of the moving body 100 predicted depending on a movement control instruction for moving the moving body 100, whether or not an incident angle at which a straight line connecting the positional information transmission apparatus 200 and the target 100a enters the target 100a falls within a prescribed range, and a control instruction changing unit 111 changing the movement control instruction based on the result of the determination.

### BACKGROUND

### Technical Field

The present invention relates to a moving body control system controlling a moving body, a moving body control apparatus, and a moving body control method.

### Background Art

In recent years, an unmanned aircraft such as a drone has been actively studied and developed. For example, the drone is used for application of image capturing to produce a video from the sky, surveying, or the like. For photographic surveying using the drone, position coordinates of the drone need to be acquired with high accuracy.

PTL 1 discloses that a prism attached to a drone is tracked by a total station having an automatic tracking function to acquire position coordinates of the drone.

### CITATION LIST

### Patent Literature

[PTL 1] JP 2018-119882 A

### SUMMARY

### Technical Problem

For example, as described in PTL 1 above, in a case that a target (for example, a prism) attached to a moving body is tracked by the total station, an orientation of the target viewed from the total station varies due to a movement of the moving body. In order that the total station tracks the target in such an environment, a target having a wide collimation possible range is needed.

In general, a prism for an automatic tracking total station has a wide collimation possible angle in a horizontal direction, but a narrow collimation possible angle in a vertical direction.

However, a moving body such as a drone moves not only in the horizontal direction but also in the vertical direction. In particular, a moving body such as a drone may move with an attitude of the body inclining. Then, when the moving body moves, an irradiation light from the automatic tracking total station may be out of the collimation possible range of the target. In such a case, the automatic tracking total station loses sight of the target attached to the moving body and cannot acquire the position coordinates of the moving body. As such, in order that the automatic tracking total station continues to acquire the position coordinates of the moving body, when the moving body moves, the moving body needs to be moved such that the irradiation light from the automatic tracking total station falls within the collimation possible range of the target.

An example object of the present invention is to provide a moving body control system, a moving body control apparatus, and a moving body control method capable of continuously acquiring positional information of a moving body without losing sight of a target provided to the moving body.

### Solution to Problem

According to an aspect of the present invention, a moving body control system includes: a moving body with a target; a positional information specifying means for irradiating the target with a light wave and specifying positional information of the target based on the light wave reflected by the target; a determining unit configured to determine whether or not positional information of the target which has moved in response to a movement control instruction for movement of the moving body can be specified, based on positional relationship between the target and the positional information specifying means, the positional relationship being predicted depending on the movement control instruction; and a changing unit configured to change the movement control instruction based on the result of the determination.

According to an aspect of the present invention, a moving body control apparatus includes: a determining unit configured to determine whether or not positional information of a target which has moved in response to a movement control instruction can be specified based on positional relationship between the target and a positional information specifying means, the target being provided to a moving body, the movement control instruction being for moving the moving body, the positional information specifying means irradiating the target with a light wave and specifying the positional information of the target based on the light wave reflected by the target, the positional relationship being predicted depending on the movement control instruction for movement of the moving body; and a changing unit configured to change the movement control instruction based on the result of the determination.

According to an aspect of the present invention, a moving body control method includes: determining whether or not positional information of a target which has moved in response to a movement control instruction can be specified based on positional relationship between the target and a positional information specifying means, the target being provided to a moving body, the movement control instruction being for moving the moving body, the positional information specifying means irradiating the target with a light wave and specifying the positional information of the target based on the light wave reflected by the target, the positional relationship being predicted depending on the movement control instruction; and changing the movement control instruction based on the result of the determination.

### Advantageous Effects of Invention

According to an aspect of the present invention, it is possible to continuously acquire positional information of a moving body without losing sight of a target provided to the moving body. Note that, according to the present invention, instead of or together with the above effects, other effects may be exerted.

### BRIEF DESCRIPTION OF THE DRAWINGS

FIG. 1 is a diagram for describing positional relationship between a total station 20 and a collimation possible range of a prism 10a attached to a moving body 10;

FIG. 2 is an explanatory diagram illustrating an example of a schematic configuration of a moving body control system 1a according to a first example embodiment;

FIG. 3 is a block diagram illustrating an example of a hardware configuration of a moving body 100 according to the first example embodiment;

FIG. 4 is a block diagram illustrating an example of a functional configuration implemented by the moving body 100;

FIG. 5 is a diagram for describing an incident angle at which an electromagnetic wave irradiated from a positional information transmission apparatus 200 enters a target 100a;

FIG. 6 is a diagram for describing a concrete example related to changing of a control parameter performed by a control instruction changing unit 111;

FIG. 7 is a flowchart for describing an example of control instruction execution processing for the moving body 100 to move so that the positional information transmission apparatus 200 does not lose sight of the moving body 100;

FIG. 8 is an explanatory diagram illustrating an example of a schematic configuration of a moving body control system 1b according to a second example embodiment;

FIG. 9 is a block diagram illustrating an example of a hardware configuration of a moving body 100 according to the second example embodiment;

FIG. 10 is a block diagram illustrating an example of a functional configuration implemented by the moving body 100;

FIG. 11 is a block diagram illustrating an example of a hardware configuration of a moving body control apparatus 400 according to the second example embodiment;

FIG. 12 is a block diagram illustrating an example of a functional configuration of the moving body control apparatus 400 according to the second example embodiment;

FIG. 13 is a flowchart for describing an example of control instruction execution processing performed by the moving body control apparatus 400 for the moving body 100 to move so that the positional information transmission apparatus 200 does not lose sight of the moving body 100;

FIG. 14 is an explanatory diagram illustrating an example of a schematic configuration of a moving body control system 1c according to a third example embodiment;

FIG. 15 is a diagram for describing a flow of processing performed by a moving body control apparatus 500 according to the third example embodiment; and

FIG. 16 is a diagram for describing examples of adapting the moving body control systems according to the first to third example embodiments to agriculture.

### DESCRIPTION OF THE EXAMPLE EMBODIMENTS

Hereinafter, example embodiments of the present invention will be described in detail with reference to the accompanying drawings. Note that, in the Specification and drawings, elements to which similar descriptions are applicable are denoted by the same reference signs, and overlapping descriptions may hence be omitted.

Descriptions will be given in the following order.

1. Overview of Example Embodiments according to the Present Invention

2. First Example Embodiment
2.1. Configuration of Moving Body Control System 1a
2.2. Configuration of Moving Body 100
2.3. Operation Example

3. Second Example Embodiment
3.1. Configuration of Moving Body Control System 1b
3.2. Configuration of Moving Body 100
3.3. Configuration of Moving Body Control Apparatus 400
3.4. Operation Example

4. Third Example Embodiment
4.1. Configuration of Moving Body Control System 1c
4.2. Operation Example

5. Application Example

6. Other Embodiment Examples

### 1. Overview of Example Embodiments according to the Present Invention

Firstly, an overview of example embodiments according to the present invention will be described.

### (1) Technical Issue

In recent years, an unmanned aircraft such as a drone has been actively studied and developed. For example, the drone is used for application of image capturing to produce a video from the sky, surveying, or the like. For photographic surveying using the drone, position coordinates of the drone need to be acquired with high accuracy.

For example, in a case that a target (for example, a prism) attached to a moving body is tracked by the total station, an orientation of the target viewed from the total station varies due to a movement of the moving body. In order that the total station tracks the target in such an environment, a target having a wide collimation possible range is needed.

In general, a prism for an automatic tracking total station has a wide collimation possible angle in a horizontal direction, but a narrow collimation possible angle in a vertical direction.

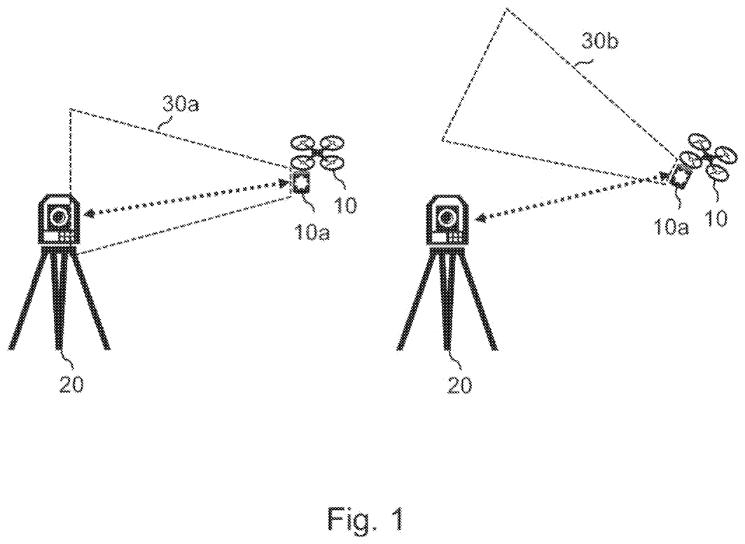

However, a moving body such as a drone moves not only in the horizontal direction but also in the vertical direction. In particular, a moving body such as a drone may move with an attitude of the body inclining. FIG. 1 is a diagram for describing positional relationship between a total station 20 and a collimation possible range of a prism 10a attached to a moving body 10. Referring to FIG. 1, in a case that an attitude of the moving body 10 does not incline, an irradiation light from the total station 20 falls within a rage of a collimation possible range 30a of the prism 10a. On the other hand, in a case that the attitude of the moving body 10 inclines, the irradiation light from the total station 20 is out of the range of the collimation possible range 30b of the prism 10a.

As described for the example in FIG. 1, when the moving body 10 moves, the irradiation light from the automatic tracking total station 20 may be out of the collimation possible range of the target (for example, the collimation possible range 30b). In such a case, the automatic tracking total station loses sight of the target attached to the moving body and cannot acquire the position coordinates of the moving body. As such, in order that the automatic tracking total station continues to acquire the position coordinates of the moving body, when the moving body moves, the moving body needs to move such that the irradiation light from the automatic tracking total station falls within the collimation possible range of the target.

In view of these, an example object the present invention is to continuously acquire positional information of a moving body without losing sight of a target provided to the moving body.

### (2) Operation Example

In the example embodiments according to the present invention, for example, determination is made, on the basis of an inclination of a moving body predicted depending on a movement control instruction for movement of the moving body with a target, on whether or not an incident angle at which a straight line connecting a positional information transmission apparatus to the target enters the target falls within a prescribed range, the positional information transmission apparatus transmitting positional information of the target on the basis of tracking the target, and the movement control instruction is changed based on the result of the determination.

This makes it possible, for example, to continuously acquire the positional information of the moving body without losing sight of the target provided to the moving body. Note that the operation example described above is merely a concrete example according to the example embodiments of the present invention, and of course, the example embodiments of the present invention is not limited to the operation example described above.

### 2. First Example Embodiment

A description will be given of a first example embodiment with reference to FIGS. 1 to 7.

### 2.1. Configuration of Moving Body Control System 1a

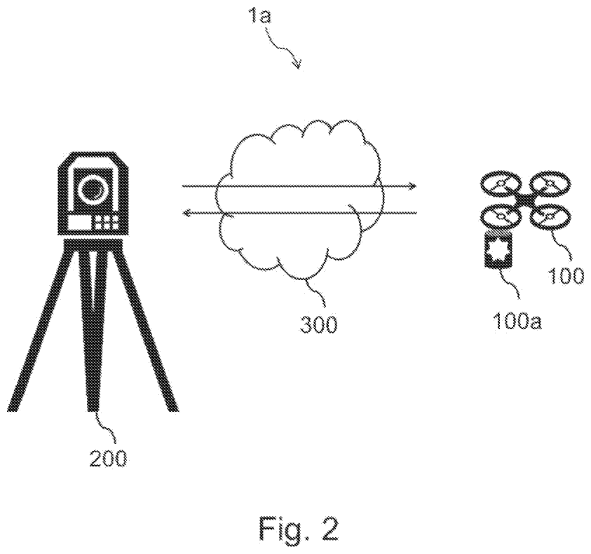

First, with reference to FIG. 2, an example of a configuration of a moving body control system 1a according to the first example embodiment will be described. FIG. 2 is an explanatory diagram illustrating an example of a schematic configuration of the moving body control system 1a according to the first example embodiment.

Referring to FIG. 2, the moving body control system 1a includes a moving body 100 with a target 100a, a positional information transmission apparatus 200, and a communication network 300.

The moving body 100 and the positional information transmission apparatus 200 are communicably connected to each other via the communication network 300.

The moving body 100 is, for example, an unmanned aircraft such as a drone. Note that the moving body 100 is not limited to the unmanned aircraft, and may be, for example, an automated guided vehicle or the like.

As illustrated in FIG. 2, the target 100a is attached to the moving body 100. The target 100a is, for example, the prism 10a. The target 100a reflects, when an incident angle of an electromagnetic wave irradiated from the positional information transmission apparatus 200 falls within a collimation possible range, the electromagnetic wave to the positional information transmission apparatus 200. The collimation possible range is determined depending on a performance of the target 100a, an attaching condition of the target 100a in the moving body 100, and the like. For example, in a case that the moving body 100 is equipped with the target 100a and a camera for image capturing, the collimation possible range of the target 100a is a range except for a range blocked by the camera because the camera blocks the electromagnetic wave.

The positional information transmission apparatus 200 specifies positional information of the target 100a and tracks the target 100a. The positional information transmission apparatus 200 is, specifically, a total station irradiating the target 100a with a light wave (electromagnetic wave). In a case that the electromagnetic wave irradiated from the positional information transmission apparatus 200 is reflected by the target 100a and is returned to the positional information transmission apparatus 200, the positional information transmission apparatus 200 can measure position coordinates of the target 100a and track the target 100a. On the other hand, in a case that the electromagnetic wave is not returned to the positional information transmission apparatus 200, the positional information transmission apparatus 200 cannot measure the position coordinates of the moving body 100 or track the target 100a.

### 2.2. Configuration of Moving Body 100

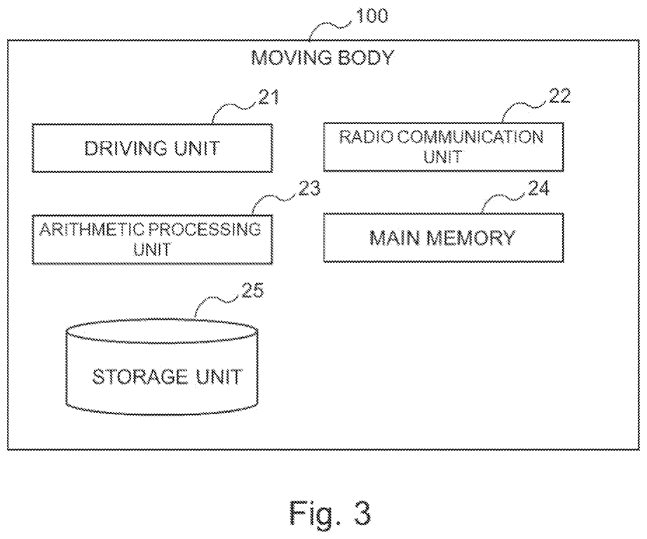

FIG. 3 is a block diagram illustrating an example of a hardware configuration of the moving body 100 according to the first example embodiment. Referring to FIG. 3, the moving body 100 includes a driving unit 21, a radio communication unit 22, an arithmetic processing unit 23, a main memory 24, and a storage unit 25.

The driving unit 21 includes, for example, means for generating driving force to move the moving body 100, such as a motor. For example, in a case that the moving body 100 is an unmanned aircraft such as a drone, a rotor is rotated due to the driving force caused by the driving unit 21 to fly the moving body 100.

The radio communication unit 22 wirelessly transmits and/or receives a signal. For example, the radio communication unit 22 receives a signal from the positional information transmission apparatus 200 via the communication network 300, and transmits a signal to the positional information transmission apparatus 200 via the communication network 300.

The arithmetic processing unit 23 is, for example, a central processing unit (CPU), a graphics processing unit (GPU), or the like. The main memory 24 is, for example, a random access memory (RAM), a read only memory (ROM), or the like.

The storage unit 25 is, for example, a hard disk drive (HDD), a solid state drive (SSD), a memory card, or the like. The storage unit 25 may be a memory such as a RAM and a ROM. Specifically, the storage unit 25 transitorily or permanently stores programs (instructions) and parameters for operations of the moving body 100 as well as various data. The programs include one or more instructions for operations of the moving body 100.

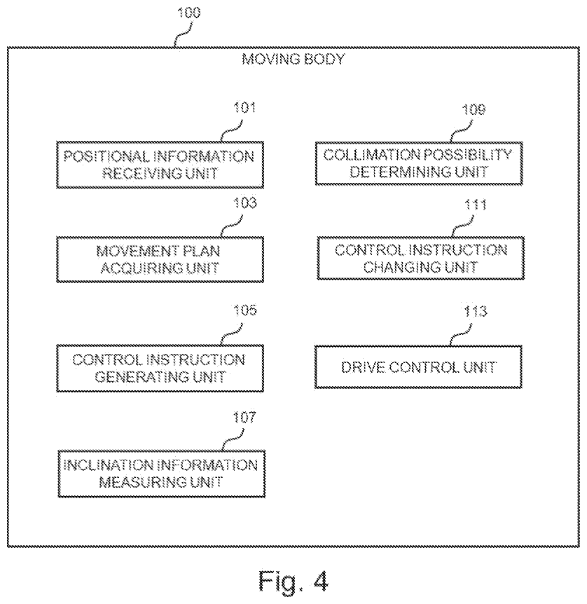

The moving body 100 reads programs for moving body control stored in the storage unit 25 onto the main memory 24 and executes the programs by the arithmetic processing unit 23 to implement functional units as illustrated in FIG. 4, for example. These programs may be read onto the main memory 24 and executed, or may be executed without being read onto the main memory 24. The main memory 24 or the storage unit 25 also functions to store information or data held by constituent components included in the moving body 100.

The programs described above can be stored by use of various types of non-transitory computer readable media to be supplied to a computer. The non-transitory computer readable media includes various types of tangible storage media. Examples of the non-transitory computer readable media include a magnetic recording medium (for example, a flexible disk, a magnetic tape, a hard disk drive), a magneto-optical recording medium (for example, a magneto-optical disk), a compact disc-ROM (CD-ROM), a CD-recordable (CD-R), a CD-rewritable (CD-R/W), a semiconductor memory (for example, a mask ROM, a programmable ROM (PROM), an erasable PROM (EPROM), a flash ROM, and a RAM. The programs may be supplied to a computer by use of various types of transitory computer readable media. Examples of the transitory computer readable media include electrical signals, optical signals, and electromagnetic waves. The transitory computer readable media can supply the programs to a computer via a wired communication path such as electrical wires and optical fibers, or a radio communication path.

FIG. 4 is a block diagram illustrating an example of a functional configuration implemented by the moving body 100.

Referring to FIG. 4, the moving body 100 includes a positional information receiving unit 101, a movement plan acquiring unit 103, a control instruction generating unit 105, an inclination information measuring unit 107, a collimation possibility determining unit 109, a control instruction changing unit 111, and a drive control unit 113. Note that the moving body 100 and the positional information transmission apparatus 200 may further include other constituent elements than those illustrated in FIG. 4.

### 2.3. Operation Example

Next, an operation example according to the first example embodiment will be described.

### (1) Transmitting and/or Receiving Positional Information of Target

In a case that the positional information transmission apparatus 200 can acquire position coordinates of the target 100a of the moving body 100, position coordinates of the target 104 is transmitted from the positional information transmission apparatus 200 to the moving body 100. The moving body 100 (the positional information receiving unit 101) receives the positional information of the target 100a from the positional information transmission apparatus 200.

### (2) Acquiring Movement Plan

The moving body 100 (the movement plan acquiring unit 103) acquires information related to a movement plan of the moving body 100. For example, in a case that the information related to the movement plan for the moving body 100 is previously stored in the storage unit 25 of the moving body 100, the moving body 100 (the movement plan acquiring unit 103) accesses the storage unit 25 to acquire the information related to the movement plan. Here, the movement plan is route information or the like for the moving body 100 to move. Note that the information related to the movement route may be not only stored in the storage unit 25, but also be sequentially transmitted from a management apparatus communicable with the moving body 100 or the like to the moving body 100, for example.

### (3) Generating Movement Control Instruction

The moving body 100 (the control instruction generating unit 105) uses the positional information of the target 100a received by the positional information receiving unit 101 and the information related to the movement plan acquired by the movement plan acquiring unit 103 to generate a movement control instruction to operate the driving unit 21.

### (4) Measuring Inclination Information

The moving body 100 (the inclination information measuring unit 107) acquires the inclination information of the moving body 100. For example, the inclination information is measured by a gyroscope sensor or the like attached to the moving body 100.

### (5) Determining for Collimation Range

The moving body 100 (the collimation possibility determining unit 109) determines whether or not the electromagnetic wave irradiated from the positional information transmission apparatus 200 falls within the collimation possible range of the target 100a provided to the moving body 100. Specifically, the moving body 100 (the collimation possibility determining unit 109) determines, on the basis of the inclination of the moving body 100 predicted depending on the movement control instruction, whether or not an incident angle at which the electromagnetic wave irradiated to the target 100a from the positional information transmission apparatus 200 enters the target 100a falls within a prescribed range.

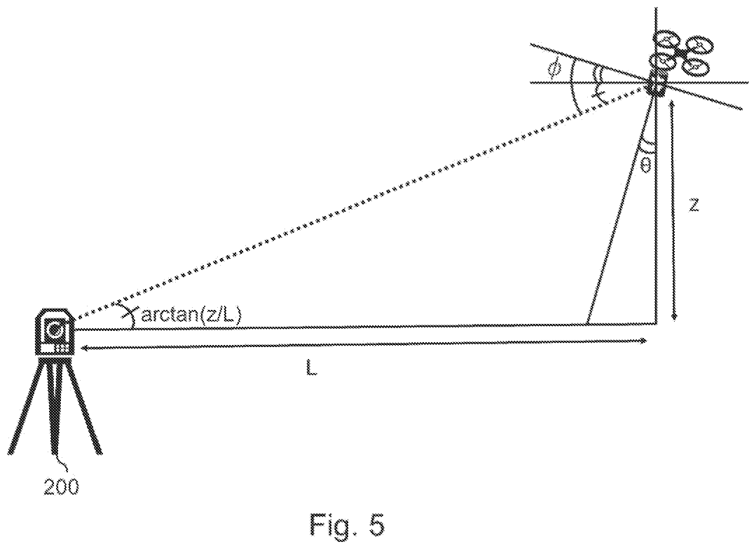

FIG. 5 is a diagram for describing the incident angle at which the electromagnetic wave irradiated from the positional information transmission apparatus 200 enters the target 100a. Referring to FIG. 5, the incident angle is calculated from position coordinates of the positional information transmission apparatus 200, position coordinates of the moving body 100, and attitude information of the moving body 100.

Assume that distances in the horizontal and vertical directions between the target 100a and the positional information transmission apparatus 200 are represented by L and z, respectively, and an inclination (attitude) of the moving body 100 is represented by θ, an incident angle φ can be calculated using an equation below.

φ=−θ−arctan(z/L)

The moving body 100 (the collimation possibility determining unit 109) previously acquires the position coordinates of the positional information transmission apparatus 200, the collimation possible range of the target 100a, and information related to positional relationship between an attached position of the target 100a and a gravity center position of the moving body 100, and receives the position coordinates of the target 100a transmitted from the positional information transmission apparatus 200 to calculate a range of the inclination of the moving body in which range the target 100a can reflect the electromagnetic wave to the positional information transmission apparatus 200.

Then, the moving body 100 (the collimation possibility determining unit 109) predicts an inclination of the moving body 100 after moving in response to the movement control instruction generated by the control instruction generating unit 105. Next, the moving body 100 (the collimation possibility determining unit 109) determines, on the basis of the inclination of the moving body 100 predicted depending on the movement control instruction, whether or not an incident angle at which the electromagnetic wave enters the target 100a falls within a prescribed range. Specifically, the moving body 100 (the collimation possibility determining unit 109) determines whether or not an attitude of the moving body 100 inclined in accordance with the prediction result falls within the range of the inclination of the moving body in which range the target 100a can reflect the electromagnetic wave to the positional information transmission apparatus 200.

### (6) Changing Movement Control Instruction

The moving body 100 (the control instruction changing unit 111) changes the movement control instruction based on a result of the determination by the collimation possibility determining unit 109. Specifically, the moving body 100 (the control instruction changing unit 111) changes, based on the result of the determination by the collimation possibility determining unit 109, in a case that the incident angle of the electromagnetic wave irradiated from the positional information transmission apparatus 200 is out of the collimation possible range of the target 100a in a state where the attitude of the moving body 100 inclines in accordance with the prediction result, the movement control instruction so that the attitude of the moving body 100 can be within a range trackable by the positional information transmission apparatus 200.

The drive control unit 113 controls the driving unit 21 in accordance with the movement control instruction changed by the control instruction changing unit 111. Because the moving body 100 (the drive control unit 113) controls the driving unit 21 in accordance with the changed movement control instruction, the positional information transmission apparatus 200 can continuously track the target 100a equipped on the moving body 100 without losing sight of the target 100a.

The moving body 100 (the control instruction changing unit 111) changes at least one control parameter of a control parameter for the altitude of the moving body 100 and a control parameter for the inclination of the moving body 100, for example, to change the movement control instruction.

### Example of Controlling Altitude

For example, an example of controlling the altitude is as below. Specifically, if the altitude is raised significantly, the electromagnetic wave irradiated from the positional information transmission apparatus 200 becomes out of the collimation possible range of the target 100a. For this reason, the moving body 100 (the control instruction changing unit 111) changes the movement control instruction such that the moving body 100 (the drone) is raised up to only the highest altitude within the collimation possible range.

### Example of Controlling Inclination

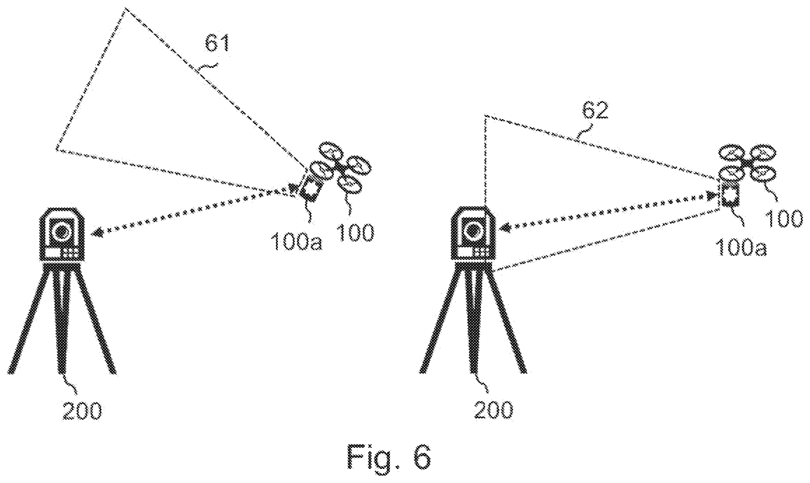

FIG. 6 is a diagram for describing a concrete example related to changing of the control parameter for controlling the inclination of the moving body 100, performed by the control instruction changing unit 111.

Referring to FIG. 6, for example, the electromagnetic wave irradiated from the positional information transmission apparatus 200 is out of a predicted collimation possible range 61 of the target 100a in a case that moving body 100 flies at a speed of 3 m/s (left diagram in FIG. 6). On the other hand, the electromagnetic wave irradiated from the positional information transmission apparatus 200 is withing a predicted collimation possible range 62 of the target 100a in a case that moving body 100 flies at a speed of 1.5 m/s (right diagram in FIG. 6). This is because the inclination of the moving body 100 varies depending on the moving speed of the moving body 100, and the collimation possible range of the target 100a varies depend on the inclination.

Accordingly, the moving body 100 (the control instruction changing unit 111) can increase or decrease the moving speed of the moving body 100 to change the control parameter for the altitude of the moving body 100 and the control parameter for the inclination of the moving body 100.

Note that the moving body 100 (the control instruction changing unit 111) may change the movement route of the moving body 100 to move via a diverted route, may be made to wait until a surrounding environment such as wind changes, or may perform other changes.

### (7) Flow of Processing

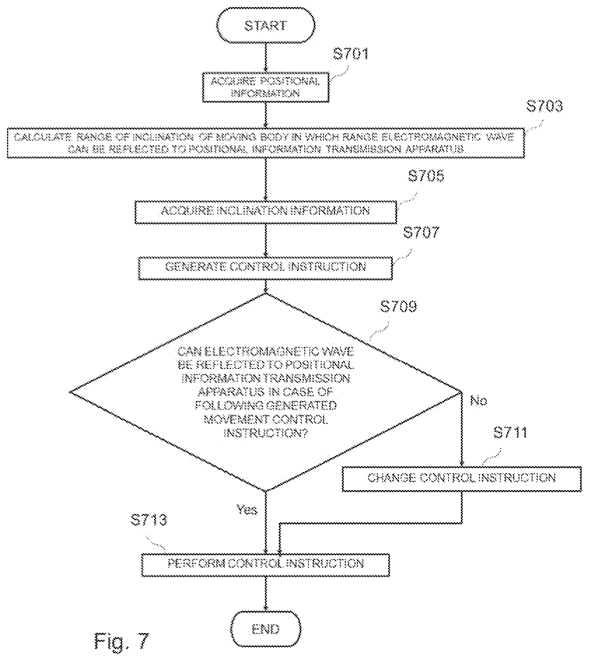

Next, referring to FIG. 7, a flow of processing performed by the moving body 100 will be described in detail. FIG. 7 is a flowchart for describing an example of control instruction execution processing for the moving body 100 to move so that the positional information transmission apparatus 200 does not lose sight of the moving body 100.

First, the moving body 100 (the collimation possibility determining unit 109) acquires positional information of the moving body 100 (step S701). Specifically, the moving body 100 (the collimation possibility determining unit 109) may receive the positional information of the moving body 100 from the positional information transmission apparatus 200, may calculate the positional information of the moving body 100 on the basis of the positional information of the target 100a to be received by the positional information receiving unit 101, or may estimate the current positional information of the moving body 100 on the basis of the positional information of the target 100a already received by the positional information receiving unit 101.

Next, the moving body 100 (the collimation possibility determining unit 109) calculates, in a case that an electromagnetic wave is irradiated from the positional information transmission apparatus 200 toward the target 100a, a range of an inclination of the moving body 100 in which range the target 100a can reflect the electromagnetic wave to the positional information transmission apparatus 200 on the basis of information of a position at which the positional information transmission apparatus 200 is located, the positional information of the moving body 100 acquired in step S701, and the collimation possible range of the target 100a (step S703).

Next, the moving body 100 (the inclination information measuring unit 107) acquires inclination information of the moving body 100 (step S705).

Next, the moving body 100 (the control instruction generating unit 105) generates a movement control instruction for next instructing the drive control unit 113 on the basis of a movement plan acquired by the movement plan acquiring unit 103 (step S707).

Next, the moving body 100 (the collimation possibility determining unit 109) determines, on the basis of the positional information of the moving body 100 acquired in step S701 and the range of the inclination of the moving body 100 in which range the electromagnetic wave can be reflected to the positional information transmission apparatus 200 acquired in step S703, whether or not an inclination of the moving body 100 that is predicted in a case of giving the movement control instruction generated in step S707 to the drive control unit 113 falls within the range of the inclination calculated in step S703 (step S709). In a case of within the range (S709: Yes), the process does not proceed to step S711, and a process in step S713 is performed. In a case of not within the range (S709: No), a process in step S711 is performed.

In step S711, the moving body 100 (the control instruction changing unit 111) changes the movement control instruction generated in step S707 so that the inclination of the moving body 100 is within the range of the inclination calculated in step S703 (step S711).

For example, in a case that a minimum value and a maximum value of the range of the inclination in a pitch direction calculated in step S703 are Φmin and Φmax, respectively, and an inclination χ of the moving body 100 in the pitch direction predicted in a case of performing the movement control instruction generated by the control instruction generating unit 105 is less than Φmin, the moving body 100 (the control instruction changing unit 111) changes the movement control instruction to change the inclination Φ of the moving body 100 in the pitch direction to χmin.

Finally, the moving body 100 (the drive control unit 113) drives the driving unit 21 in accordance with the movement control instruction, and the process ends (step S713).

According to the process illustrated in FIG. 7, a probability can be reduced that the positional information transmission apparatus 200 loses sight of the target 100a attached to moving body 100 to cause the positional information of the target 100a to be not acquired.

### (8) Example Alteration

Note that in a case that the positional information transmission apparatus 200 loses sight of the target 100a to cause the positional information of the target 100a to not be transmitted, the moving body 100 (the control instruction generating unit 105) may generate a movement control instruction for waiting at the current position, a movement control instruction for returning to a position before the positional information transmission apparatus 200 loses the sight, or a movement control instruction for landing on the current location.

### 3. Second Example Embodiment

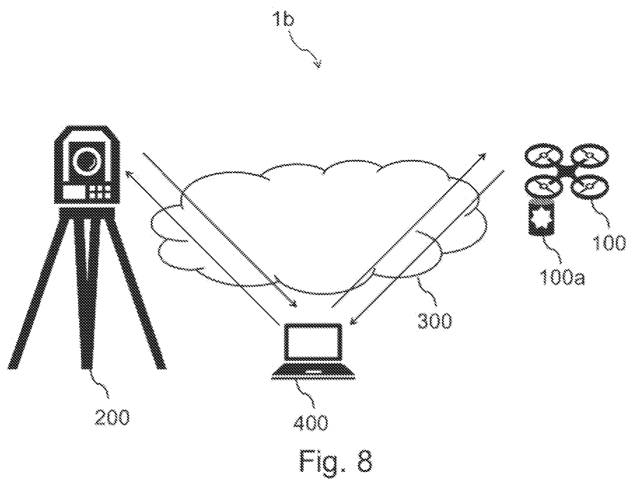

A description will be given of a second example embodiment with reference to FIGS. 8 to 13.

### 3.1. Configuration of Moving Body Control System 1b

With reference to FIG. 8, an example of a configuration of a moving body control system 1b according to the second example embodiment will be described. FIG. 8 is an explanatory diagram illustrating an example of a schematic configuration of the moving body control system 1b according to the second example embodiment.

Referring to FIG. 8, the moving body control system 1b includes the moving body 100 with the target 100a, the positional information transmission apparatus 200, the communication network 300, and a moving body control apparatus 400.

The moving body 100 and the moving body control apparatus 400 are communicably connected to each other via the communication network 300. The positional information transmission apparatus 200 and the moving body control apparatus 400 are communicably connected to each other via the communication network 300.

The moving body 100 is, for example, an unmanned aircraft such as a drone. Note that the moving body 100 is not limited to the unmanned aircraft, and may be, for example, an automated guided vehicle or the like.

As illustrated in FIG. 2, the target 100a is attached to the moving body 100. The target 100a is, for example, a prism. The target 100a reflects, when an incident angle of an electromagnetic wave irradiated from the positional information transmission apparatus 200 falls within a collimation possible range, the electromagnetic wave to the positional information transmission apparatus 200. The collimation possible range is determined depending on a performance of the target 100a itself, an attaching condition of the target 100a in the moving body 100, and the like. For example, in a case that the moving body 100 is equipped with the target 100a and a camera for image capturing, the collimation possible range of the target 100a is a range except for a range blocked by the camera because the camera blocks the electromagnetic wave.

The positional information transmission apparatus 200 specifies positional information of the target 100a and tracks the target 100a. The positional information transmission apparatus 200 is, specifically, a total station irradiating the target with a light wave (electromagnetic wave). In a case that the electromagnetic wave irradiated from the positional information transmission apparatus 200 is reflected by the target 100a and is returned to the positional information transmission apparatus 200, the positional information transmission apparatus 200 can measure position coordinates of the target 100a and track the target 100a. On the other hand, in a case that the electromagnetic wave is not returned to the positional information transmission apparatus 200, the positional information transmission apparatus 200 cannot measure the position coordinates of the moving body 100 or track the target 100a.

The moving body control apparatus 400 controls the moving body 100 on the basis of the positional information collected from the positional information transmission apparatus 200 and the moving body 100. Details are described later.

### 3.2. Configuration of Moving Body 100

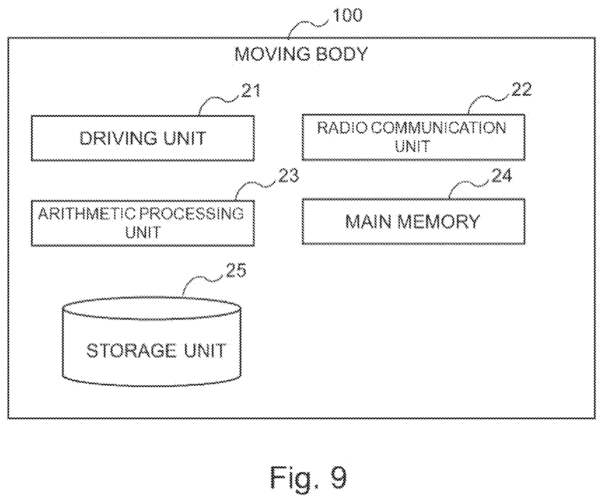

FIG. 9 is a block diagram illustrating an example of a hardware configuration of the moving body 100 according to the second example embodiment. Referring to FIG. 9, the moving body 100 includes the driving unit 21, the radio communication unit 22, the arithmetic processing unit 23, the main memory 24, and the storage unit 25.

The driving unit 21 includes, for example, means for generating driving force to move the moving body 100, such as a motor. For example, in a case that the moving body 100 is an unmanned aircraft such as a drone, a rotor is rotated due to the driving force caused by the driving unit 21 to fly the moving body 100.

The radio communication unit 22 wirelessly transmits and/or receives a signal. For example, the radio communication unit 22 receives a signal from the moving body 100 via the communication network 300, and transmits a signal to the moving body 100 via the communication network 300.

The arithmetic processing unit 23 is, for example, a central processing unit (CPU), a graphics processing unit (GPU), or the like. The main memory 24 is, for example, a random access memory (RAM), a read only memory (ROM), or the like.

The storage unit 25 is, for example, a hard disk drive (HDD), a solid state drive (SSD), a memory card, or the like. The storage unit 25 may be a memory such as a RAM and a ROM. Specifically, the storage unit 25 transitorily or permanently stores programs (instructions) and parameters for operations of the moving body 100 as well as various data. The programs include one or more instructions for operations of the moving body 100.

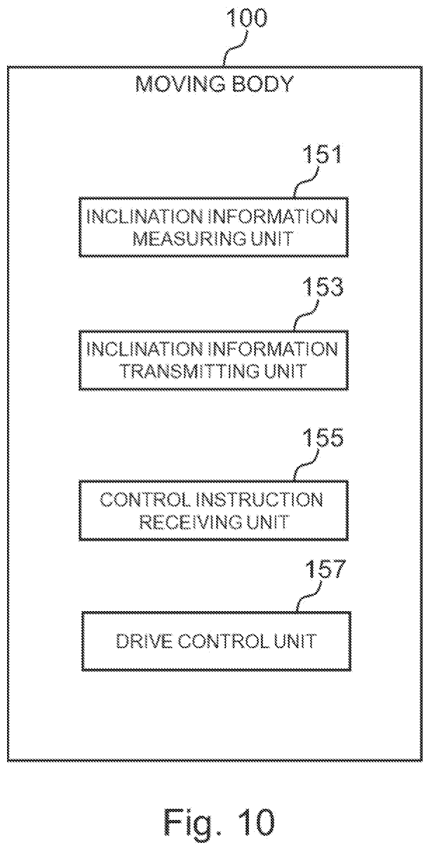

The moving body 100 reads programs for moving body control stored in the storage unit 25 onto the main memory 24 and executes the programs by the arithmetic processing unit 23 to implement functional units as illustrated in FIG. 10, for example. These programs may be read onto the main memory 24 and executed, or may be executed without being read onto the main memory 24. The main memory 24 or the storage unit 25 also functions to store information or data held by constituent components included in the moving body 100.

The programs described above can be stored by use of various types of non-transitory computer readable media to be supplied to a computer. The non-transitory computer readable media includes various types of tangible storage media. Examples of the non-transitory computer readable media include a magnetic recording medium (for example, a flexible disk, a magnetic tape, a hard disk drive), a magneto-optical recording medium (for example, a magneto-optical disk), a compact disc-ROM (CD-ROM), a CD-recordable (CD-R), a CD-rewritable (CD-R/W), a semiconductor memory (for example, a mask ROM, a programmable ROM (PROM), an erasable PROM (EPROM), a flash ROM, and a RAM. The programs may be supplied to a computer by use of various types of transitory computer readable media. Examples of the transitory computer readable media include electrical signals, optical signals, and electromagnetic waves. The transitory computer readable media can supply the programs to a computer via a wired communication path such as electrical wires and optical fibers, or a radio communication path.

FIG. 10 is a block diagram illustrating an example of a functional configuration implemented by the moving body 100.

Referring to FIG. 10, the moving body 100 includes an inclination information measuring unit 151, an inclination information transmitting unit 153, a control instruction receiving unit 155, and a drive control unit 157. Note that the moving body 100 may further include other constituent elements than those illustrated in FIG. 10.

### 3.3. Configuration of Moving Body Control Apparatus 400

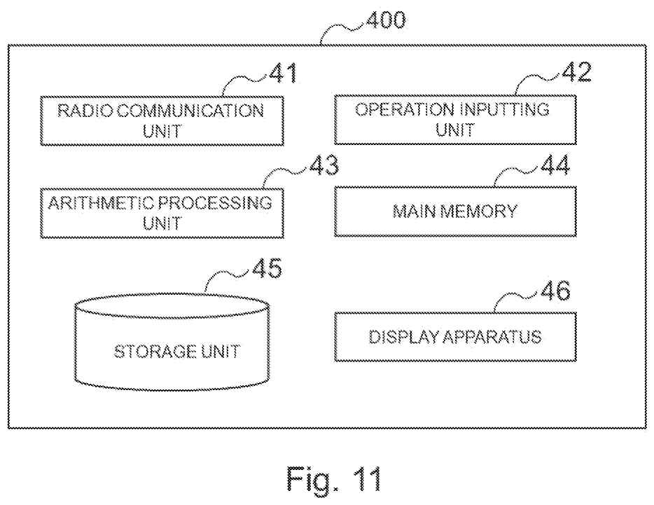

FIG. 11 is a block diagram illustrating an example of a hardware configuration of the moving body control apparatus 400 according to the second example embodiment. Referring to FIG. 11, the moving body control apparatus 400 includes a radio communication unit 41, an operation inputting unit 42, an arithmetic processing unit 43, a main memory 44, a storage unit 45, and a display apparatus 46.

The radio communication unit 41 wirelessly transmits and/or receives a signal. For example, the radio communication unit 41 receives signals from the moving body 100 and the positional information transmission apparatus 200 via the communication network 300, and transmits signals to the moving body 100 and the positional information transmission apparatus 200 via the communication network 300.

The operation inputting unit 42 is an input interface performing input processing of operation request from a user operating the moving body control apparatus 400.

The arithmetic processing unit 43 is, for example, a central processing unit (CPU), a graphics processing unit (GPU), or the like. The main memory 44 is, for example, a random access memory (RAM), a read only memory (ROM), or the like.

The storage unit 45 is, for example, a hard disk drive (HDD), a solid state drive (SSD), a memory card, or the like. The storage unit 45 may be a memory such as a RAM and a ROM. Specifically, the storage unit 45 transitorily or permanently stores programs (instructions) and parameters for operations of the moving body control apparatus 400 as well as various data. The programs include one or more instructions for operations of the moving body control apparatus 400.

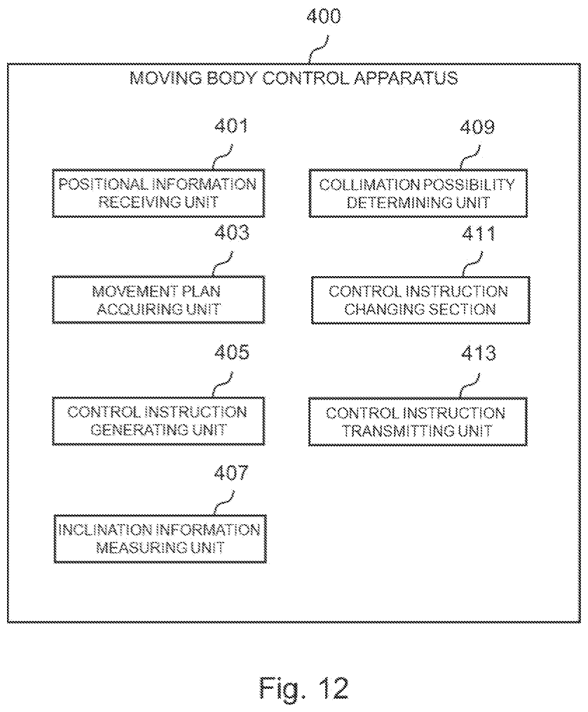

The moving body control apparatus 400 reads programs for moving body control stored in the storage unit 45 onto the main memory 44 and executes the programs by the arithmetic processing unit 43 to implement functional units as illustrated in FIG. 12, for example. These programs may be read onto the main memory 44 and executed, or may be executed without being read onto the main memory 44. The main memory 44 or the storage unit 45 also functions to store information or data held by constituent components included in the moving body control apparatus 400.

The programs described above can be stored by use of various types of non-transitory computer readable media to be supplied to a computer. The non-transitory computer readable media includes various types of tangible storage media. Examples of the non-transitory computer readable media include a magnetic recording medium (for example, a flexible disk, a magnetic tape, a hard disk drive), a magneto-optical recording medium (for example, a magneto-optical disk), a compact disc-ROM (CD-ROM), a CD-recordable (CD-R), a CD-rewritable (CD-R/W), a semiconductor memory (for example, a mask ROM, a programmable ROM (PROM), an erasable PROM (EPROM), a flash ROM, and a RAM. The programs may be supplied to a computer by use of various types of transitory computer readable media. Examples of the transitory computer readable media include electrical signals, optical signals, and electromagnetic waves. The transitory computer readable media can supply the programs to a computer via a wired communication path such as electrical wires and optical fibers, or a radio communication path.

A display apparatus 46 is an apparatus displaying a screen corresponding to rendered data processed by the arithmetic processing unit 23, such as a liquid crystal display (LCD), a cathode ray tube (CRT) display, and a monitor.

FIG. 12 is a block diagram illustrating an example of a functional configuration of the moving body control apparatus 400 according to the second example embodiment. Referring to FIG. 12, the moving body control apparatus 400 includes a positional information receiving unit 401, a movement plan acquiring unit 403, a control instruction generating unit 405, an inclination information receiving unit 407, a collimation possibility determining unit 409, a control instruction changing unit 411, and a control instruction transmitting unit 413. Note that the moving body control apparatus 400 may further include constituent elements other than these constituent elements.

### 3.4. Operation Example

Next, an operation example according to the second example embodiment will be described.

### (1) Transmitting and/or Receiving Positional Information of Target

In a case that the positional information transmission apparatus 200 can acquire position coordinates of the target 100a of the moving body 100, position coordinates of the target 104 is transmitted from the positional information transmission apparatus 200 to the moving body control apparatus 400. The moving body control apparatus 400 (the positional information receiving unit 401) receives the positional information of the target 100a from the positional information transmission apparatus 200.

### (2) Acquiring Movement Plan

The moving body control apparatus 400 (the movement plan acquiring unit 403) acquires information related to a movement plan of the moving body 100. For example, in a case that the information related to the movement plan for the moving body 100 is previously stored in the storage unit 45 of the moving body control apparatus 400, the moving body control apparatus 400 (the movement plan acquiring unit 403) accesses the storage unit 45 to acquire the information related to the movement plan. Here, the movement plan is route information or the like for the moving body 100 to move. Note that the information related to the movement route may be not only stored in the storage unit 45, but also be sequentially transmitted from a management apparatus communicable with the moving body control apparatus 400 or the like to the moving body control apparatus 400, for example.

### (3) Generating Movement Control Instruction

The moving body control apparatus 400 (the control instruction generating unit 405) uses the positional information of the target 100a received by the positional information receiving unit 401 and the information related to the movement plan acquired by the movement plan acquiring unit 403 to generate a movement control instruction to control movement of the moving body 100.

### (4) Measuring and Transmitting and/or Receiving Inclination Information

The moving body 100 (the inclination information measuring unit 151) acquires the inclination information of the moving body 100. For example, the inclination information is measured by a gyroscope sensor or the like attached to the moving body 100. Then, the inclination information of the moving body 100 is transmitted by the moving body 100 (the inclination information transmitting unit 153) and received by the moving body control apparatus 400 (the inclination information receiving unit 407).

### (5) Determining for Collimation Range

The moving body control apparatus 400 (the collimation possibility determining unit 409) determines whether or not the electromagnetic wave irradiated from the positional information transmission apparatus 200 falls within the collimation possible range of the target 100a provided to the moving body 100. Specifically, the moving body control apparatus 400 (the collimation possibility determining unit 409) determines, on the basis of the inclination of the moving body 100 predicted depending on the movement control instruction, whether or not an incident angle at which the electromagnetic wave irradiated to the target 100a from the positional information transmission apparatus 200 enters the target 100a falls within a prescribed range.

Calculation of the incident angle at which the electromagnetic wave irradiated from the positional information transmission apparatus 200 enters the target 100a is the same as in the first example embodiment referring to FIG. 5, and thus, the description thereof is omitted.

The moving body control apparatus 400 (the collimation possibility determining unit 409) previously acquires the position coordinates of the positional information transmission apparatus 200, the collimation possible range of the target 100a, and positional relationship between an attached position of the target 100a and a gravity center position of the moving body 100, and receives the position coordinates of the target 100a transmitted from the positional information transmission apparatus 200 to calculate a range of the inclination of the moving body in which range the target 100a can reflect the electromagnetic wave to the positional information transmission apparatus 200.

Then, the moving body control apparatus 400 (the collimation possibility determining unit 409) predicts an inclination of the moving body 100 after moving in response to the movement control instruction generated by the control instruction generating unit 405. Next, the moving body control apparatus 400 (the collimation possibility determining unit 409) determines, on the basis of the inclination of the moving body 100 predicted depending on the movement control instruction, whether or not an incident angle at which the electromagnetic wave enters the target 100a falls within a prescribed range. Specifically, the moving body control apparatus 400 (the collimation possibility determining unit 409) determines whether or not an attitude of the moving body 100 inclined in accordance with the prediction result falls within the range of the inclination of the moving body in which range the target 100a can reflect the electromagnetic wave to the positional information transmission apparatus 200.

### (6) Changing Movement Control Instruction

The moving body control apparatus 400 (the control instruction changing unit 411) changes the movement control instruction based on a result of the determination by the collimation possibility determining unit 409. Specifically, the moving body control apparatus 400 (the control instruction changing unit 411) changes, based on the result of the determination by the collimation possibility determining unit 409, in a case that the incident angle of the electromagnetic wave irradiated from the positional information transmission apparatus 200 is out of the collimation possible range of the target 100a in a state where the attitude of the moving body 100 inclines in accordance with the prediction result, the movement control instruction so that the attitude of the moving body 100 can be within a range trackable by the positional information transmission apparatus 200. The changed movement control instruction is transmitted by the moving body control apparatus 400 (the control instruction transmitting unit 413) and received by the moving body 100 (the control instruction receiving unit 155).

The drive control unit 157 controls the driving unit 21 in accordance with the movement control instruction changed by the control instruction changing unit 111. Because the moving body 100 (the drive control unit 157) controls the driving unit 21 in accordance with the changed movement control instruction, the positional information transmission apparatus 200 can continuously track the target 100a equipped on the moving body 100 without losing sight of the target 100a.

The moving body control apparatus 400 (the control instruction changing unit 411) changes at least one control parameter of a control parameter for the altitude of the moving body 100 and a control parameter for the inclination of the moving body 100, for example, to change the movement control instruction.

A concrete example of the change of the control parameter by the control instruction changing unit 411 is the same as in the first example embodiment referring to FIG. 6 and the like, and thus, the description thereof is omitted.

Note that the moving body control apparatus 400 (the control instruction changing unit 411) may change the route the moving body 100 travels to move via a diverted route, may be made to wait until a surrounding environment such as wind changes, or may perform other changes.

### (7) Flow of Processing

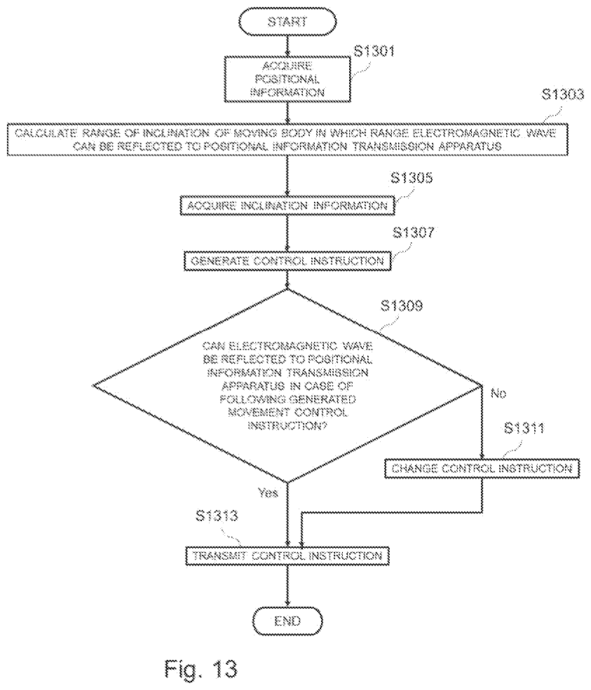

Next, referring to FIG. 13, a flow of processing performed by the moving body control apparatus 400 will be described in detail. FIG. 13 is a flowchart for describing an example of control instruction execution processing performed by the moving body control apparatus 400 for the moving body 100 to move so that the positional information transmission apparatus 200 does not lose sight of the moving body 100.

First, the moving body control apparatus 400 (the collimation possibility determining unit 409) acquires positional information of the moving body 100 (step S1301). Specifically, the moving body control apparatus 400 (the collimation possibility determining unit 409) may receive the positional information of the moving body 100 from the positional information transmission apparatus 200, may calculate the positional information of the moving body 100 on the basis of the positional information of the target 100a to be received by the positional information receiving unit 401, or may estimate the current positional information of the moving body 100 on the basis of the positional information of the target 100a already received by the positional information receiving unit 401.

Next, the moving body control apparatus 400 (the collimation possibility determining unit 409) calculates, in a case that an electromagnetic wave is irradiated from the positional information transmission apparatus 200 toward the target 100a, a range of an inclination of the moving body 100 in which range the target 100a can reflect the electromagnetic wave to the positional information transmission apparatus 200 on the basis of information of a position at which the positional information transmission apparatus 200 is located, the positional information of the moving body 100 acquired in step S1301, and the collimation possible range of the target 100a (step S1303).

Next, the moving body control apparatus 400 (the inclination information receiving unit 407) acquires inclination information of the moving body 100 from the moving body 100 (step S1305).

Next, the moving body control apparatus 400 (the control instruction generating unit 405) generates a movement control instruction to be transmitted the moving body 100 on the basis of a movement plan acquired by the movement plan acquiring unit 403 (step S1307).

Next, the moving body control apparatus 400 (the collimation possibility determining unit 409) determines, on the basis of the positional information of the moving body 100 acquired in step S1301 and the range of the inclination of the moving body 100 in which range the electromagnetic wave can be reflected to the positional information transmission apparatus 200 acquired in step S1303, whether or not an inclination of the moving body 100 that is predicted in a case of giving the movement control instruction generated in step S1307 to the moving body 100 falls within the range of the inclination calculated in step S1303 (step S1309). In a case of within the range (S1309: Yes), the process does not proceed to step S1311, and a process in step 1313 is performed. In a case of not within the range (S1309: No), a process in step S1311 is performed.

In step S1311, the moving body control apparatus 400 (the control instruction changing unit 411) changes the movement control instruction generated in step S1307 so that the inclination of the moving body 100 is within the range of the inclination calculated in step S1303 (step S1311).

For example, in a case that a minimum value and a maximum value of the range of the inclination in a pitch direction calculated in step S1303 are Φmin and Φmax, respectively, and an inclination Φ of the moving body 100 in the pitch direction predicted in a case of performing the movement control instruction generated by the control instruction generating unit 405 is less than Φmin, the moving body control apparatus 400 (the control instruction changing unit 411) changes the movement control instruction to change the inclination Φ of the moving body 100 in the pitch direction to Φmin.

Finally, the moving body control apparatus 400 (the control instruction transmitting unit 413) transmits the movement control instruction to the moving body 100, and the process ends (step S1313).

According to the process illustrated in FIG. 13, a probability can be reduced that the positional information transmission apparatus 200 loses sight of the target 100a attached to moving body 100 to cause the positional information of the target 100a to be not acquired.

### (8) Example Alteration

Note that in a case that the positional information transmission apparatus 200 loses sight of the target 100a to cause the positional information of the target 100a to not be transmitted, the moving body control apparatus 400 (the control instruction generating unit 405) may generate a movement control instruction for waiting at the current position, a movement control instruction for returning to a position before the positional information transmission apparatus 200 loses the sight, or a movement control instruction for landing on the current location.

### 4. Third Example Embodiment

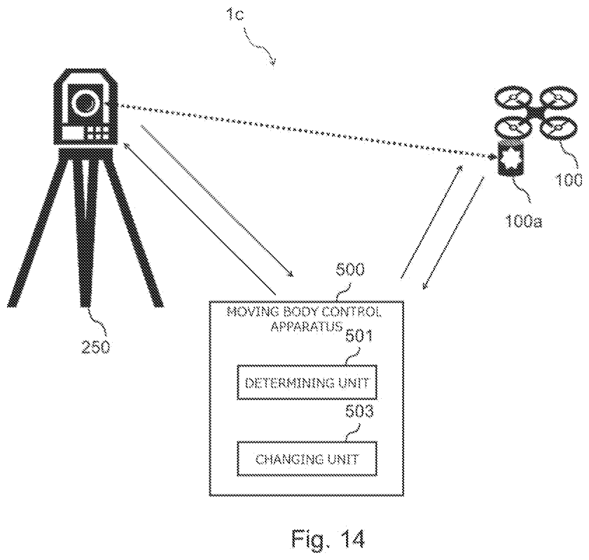

Subsequently, a description will be given of a third example embodiment with reference to FIGS. 14 to 16. The above-described first and second example embodiments are concrete example embodiments, whereas the third example embodiment is a more generalized example embodiment.

### 4.1. Configuration of Moving Body Control System 1c

First, with reference to FIG. 14, an example of a configuration of a moving body control system 1c according to the third example embodiment will be described. FIG. 14 is an explanatory diagram illustrating an example of a schematic configuration of the moving body control system 1c according to the third example embodiment.

Referring to FIG. 14, the moving body control system 1c includes the moving body 100 with the target 100a, a positional information specifying apparatus 250, and a moving body control apparatus 500.

In the moving body control system 1c, the positional information specifying apparatus 250 specifies positional information of the target 100a and tracks the target 100a. For example, the positional information specifying apparatus 250 transmits the positional information of the target 100a on the basis of tracking the target 100a provided to the moving body 100 to, for example, the moving body control apparatus 500.

The moving body control apparatus 500 is mounted, for example, in the moving body 100 or in the positional information specifying apparatus 250. Note that the moving body control apparatus 500 may be an external apparatus communicable with the moving body 100 and the positional information specifying apparatus 250.

The moving body control apparatus 500 includes a determining unit 501 and a changing unit 503. The determining unit 501 and the changing unit 503 may be implemented with one or more processors, a memory (e.g., a nonvolatile memory and/or a volatile memory), and/or a hard disk. The determining unit 501 and the changing unit 503 may be implemented with the same processor or may be implemented with separate processors. The memory may be included in the one or more processors or may be provided outside the one or more processors.

### 4.2. Operation Example

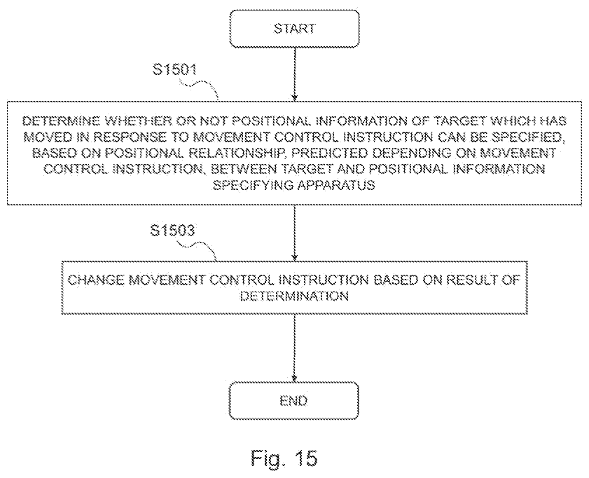

An operation example according to the third example embodiment will be described. FIG. 15 is a diagram for describing a flow of processing performed by the moving body control apparatus 500 according to the third example embodiment.

According to the third example embodiment, the moving body control apparatus 500 (the determining unit 501) determines whether or not positional information of the target 100a which has moved in response to movement control instruction for moving the moving body 100 can be specified, based on positional relationship between target 100a and the positional information specifying apparatus 250, the positional relationship being predicted depending on the movement control instruction (step S1501).

Specifically, the moving body control apparatus 500 (the determining unit 501) determines whether or not the positional information of the target 100a which has moved in response to the movement control instruction can be specified, on the basis of, for example, whether or not information related to the positional relationship such as an inclination of the target 100a with respect to the positional information specifying apparatus 250, an altitude of the target 100a with respect to the positional information specifying apparatus 250, or a distance from the target 100a to the positional information specifying apparatus 250 meets a prescribed condition.

Next, the moving body control apparatus 500 (the changing unit 503) changes the movement control instruction based on the result of the determination in step S1501 (step S1503).

### Relationship with First and Second Example Embodiments

In an example, the determining unit 501 included in the moving body control apparatus 500 may perform the operations of the collimation possibility determining unit 109 included in the moving body 100 in the first example embodiment or the collimation possibility determining unit 409 included in the moving body control apparatus 400 in the second example embodiment. The changing unit 503 included in the moving body control apparatus 500 may perform the operations of the control instruction changing unit 111 included in the moving body 100 in the first example embodiment or the control instruction changing unit 411 included in the moving body control apparatus 400 in the second example embodiment. In this case, the descriptions of the first and second example embodiments may be applicable to the third example embodiment.

Note that the third example embodiment is not limited to this example.

The third example embodiment has been described above. According to the third example embodiment, it possible, for example, to continuously acquire the positional information of the moving body without losing sight of the target provided to the moving body 100.

### 5. Application Example

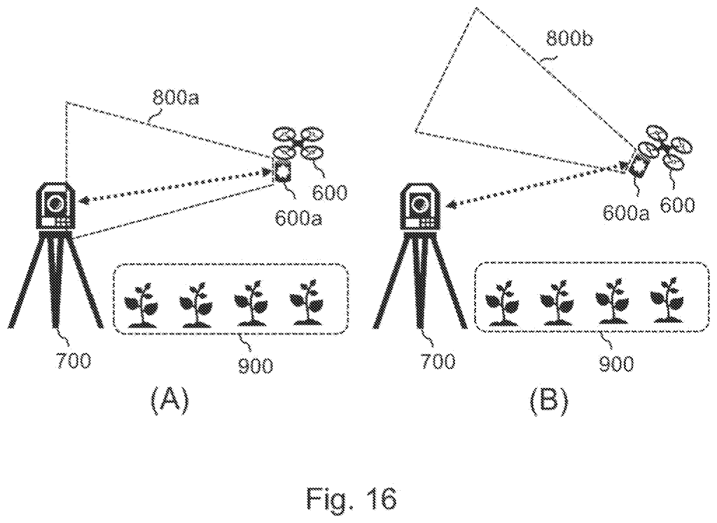

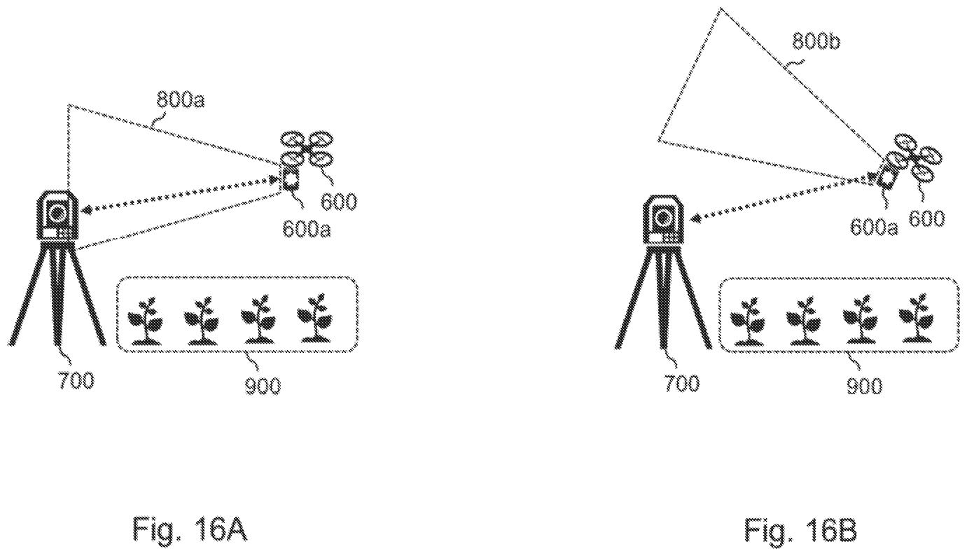

With reference to FIG. 16, a description is given of examples of adapting the moving body control systems according to the first to third example embodiments to agriculture. FIG. 16 is a diagram for describing examples of applying the moving body control systems according to the first to third example embodiments to agriculture.

Referring to FIG. 16, a moving body 600 flies over agricultural crops, and uses a camera or the like mounted on the moving body 600 to acquire information for checking a growth situation of agricultural crops 900 (hereinafter, an expression of monitoring the agricultural crops 900 may be used). The moving body 600 acquires positional information of the moving body 600 from a total station 700 to control a flying position of the moving body 600 itself so that the moving body 600 flies over the agricultural crops 900 that is a target of image capturing.

Next, referring to FIG. 16(A), a case that an attitude of the moving body 600 does not incline is described. In the case that the attitude of the moving body 600 does not incline, an irradiation light from the total station 700 falls within a range of a collimation possible range 800a of a prism 600a provided to the moving body 600. Therefore, the moving body 600 acquires the positional information of the moving body 600 from the total station 700 and controls the position of the moving body 600 to monitor the agricultural crops 900.

Next, referring to FIG. 16(B), a case that the attitude of the moving body 600 inclines is described. The case that the attitude of the moving body 600 inclines is, for example, a case that the moving body 600 steeply turns, or a case that a flight speed of the moving body 600 is slow. In such a case, the total station 700 automatically tracking the moving body 600 loses sight of the prism 600a (the target) attached to the moving body 600 and cannot acquire the position coordinates of the moving body 600. For this reason, the moving body 600 predicts an inclination of the moving body 600 after the moving body 600 moves in response to the movement control instruction, and changes the movement control instruction so that an attitude of moving body 600 inclined in response to a prediction result falls within a range of the inclination of the moving body 600 in which range the prism 600a (the target) can reflect an electromagnetic wave to the total station 700.

The above example is in a case that the moving body 600 inclines to cause an irradiation light from the total station 700 to become out of the collimation range of the prism 600a, but the application example is not limited to this case. For example, the above example may be applied to a case that the altitude of the moving body 600 with respect to the total station 700 is higher than a prescribed altitude, or a case that the distance between the total station 700 and the moving body 600 is farther than a prescribed distance.

Note that the example of applying the moving body control system is adapted to agriculture is described using FIG. 16, but the present invention is not limited thereto. For example, the moving body control system according to the present invention may be adapted to checking a growth situation of forest trees in forestry, monitoring behaviors of domestic animals in stock farming, or monitoring for security at an event venue.

### 6. Other Embodiment Examples

Descriptions have been given above of the example embodiments of the present invention. However, the present invention is not limited to these example embodiments. It should be understood by those of ordinary skill in the art that these example embodiments are merely examples and that various alterations are possible without departing from the scope and the spirit of the present invention.

For example, the steps in the processing described in the Specification may not necessarily be executed in time series in the order described in the corresponding flowchart. For example, the steps in the processing may be executed in an order different from that described in the corresponding flowchart or may be executed in parallel. Some of the steps in the processing may be deleted, or more steps may be added to the processing.

Moreover, methods including processing of the constituent elements of the moving body control system described in the Specification may be provided, and programs for causing a processor to execute processing of the constituent elements may be provided. Moreover, non-transitory computer readable recording media (non-transitory computer readable media) having recorded thereon the programs may be provided.

The whole or part of the example embodiments disclosed above can be described as, but not limited to, the following supplementary notes.

### (Supplementary Note 1)

A moving body control system comprising:

a moving body with a target;

a positional information specifying means for irradiating the target with a light wave and specifying positional information of the target based on the light wave reflected by the target;

a determining unit configured to determine whether or not positional information of the target which has moved in response to a movement control instruction for movement of the moving body can be specified, based on positional relationship between the target and the positional information specifying means, the positional relationship being predicted depending on the movement control instruction; and

a changing unit configured to change the movement control instruction based on the result of the determination.

### (Supplementary Note 2)

The moving body control system according to Supplementary Note 1, wherein the determining unit is configured to determine whether or not the light wave irradiated from the positional information specifying means falls within a collimation possible range of the target.

### (Supplementary Note 3)

The moving body control system according to Supplementary Note 1 or 2, wherein the moving body is an unmanned aircraft.

### (Supplementary Note 4)

The moving body control system according to any one of Supplementary Notes 1 to 3, wherein the changing unit is configured to change a control parameter for controlling an altitude of the moving body to change the movement control instruction.

### (Supplementary Note 5)

The moving body control system according to any one of Supplementary Notes 1 to 3, wherein the changing unit is configured to change a control parameter for controlling an inclination of the moving body to change the movement control instruction.

### (Supplementary Note 6)

A moving body control apparatus comprising:

a determining unit configured to determine whether or not positional information of a target which has moved in response to a movement control instruction can be specified based on positional relationship between the target and a positional information specifying means, the target being provided to a moving body, the movement control instruction being for moving the moving body, the positional information specifying means irradiating the target with a light wave and specifying the positional information of the target based on the light wave reflected by the target, the positional relationship being predicted depending on the movement control instruction for movement of the moving body; and

a changing unit configured to change the movement control instruction based on the result of the determination.

### (Supplementary Note 7)

The moving body control apparatus according to Supplementary Note 6, wherein the determining unit is configured to determine whether or not the light wave irradiated from the positional information specifying means falls within a collimation possible range of the target.

### (Supplementary Note 8)

The moving body control apparatus according to Supplementary Note 6 or 7, wherein the moving body is an unmanned aircraft.

### (Supplementary Note 9)

The moving body control apparatus according to any one of Supplementary Notes 6 to 8, wherein the changing unit is configured to change a control parameter for controlling an altitude of the moving body to change the movement control instruction.

### (Supplementary Note 10)

The moving body control apparatus according to any one of Supplementary Notes 6 to 8, wherein the changing unit is configured to change a control parameter for controlling an inclination of the moving body to change the movement control instruction.

### (Supplementary Note 11)

A moving body control method comprising:

determining whether or not positional information of a target which has moved in response to a movement control instruction can be specified based on positional relationship between the target and a positional information specifying means, the target being provided to a moving body, the movement control instruction being for moving the moving body, the positional information specifying means irradiating the target with a light wave and specifying the positional information of the target based on the light wave reflected by the target, the positional relationship being predicted depending on the movement control instruction; and

changing the movement control instruction based on the result of the determination.

### (Supplementary Note 12)

The moving body control method according to Supplementary Note 11, wherein the determining is determining whether or not the light wave irradiated from the positional information specifying means falls within a collimation possible range of the target.

### (Supplementary Note 13)

The moving body control method according to Supplementary Note 11 or 12, wherein the moving body is an unmanned aircraft.

### (Supplementary Note 14)

The moving body control method according to any one of Supplementary Notes 11 to 13, wherein the changing the movement control instruction includes changing a control parameter for controlling an altitude of the moving body to change the movement control instruction.

### (Supplementary Note 15)

The moving body control method according to any one of Supplementary Notes 11 to 13, wherein the changing the movement control instruction includes changing a control parameter for controlling an inclination of the moving body to change the movement control instruction.

### (Supplementary Note 16)

A moving body control program causing a computer to execute:

determining whether or not positional information of a target which has moved in response to a movement control instruction can be specified based on positional relationship between the target and a positional information specifying means, the target being provided to a moving body, the movement control instruction being for moving the moving body, the positional information specifying means irradiating the target with a light wave and specifying the positional information of the target based on the light wave reflected by the target, the positional relationship being predicted depending on the movement control instruction; and

changing the movement control instruction based on the result of the determination.

### INDUSTRIAL APPLICABILITY

In the moving body control system controlling the movement of the moving body, the positional information of the moving body can be continuously acquired without losing sight of the target provided to the moving body.

Reference Signs List

| 1a, 1b, 1c | Moving Body Control System |
|---|---|
| 10, 100, 600 | Moving Body |
| 20, 700 | Total Station |
| 200 | Positional Information Transmission Apparatus |
| 250 | Positional Information Specifying Apparatus |
| 300 | Communication Network |
| 400, 500 | Moving Body Control Apparatus |
| 101, 401 | Positional Information Receiving Unit |
| 103, 403 | Movement Plan Acquiring Unit |
| 105, 405 | Control Instruction Generating Unit |
| 107, 151 | Inclination Information Measuring Unit |
| 109, 409 | Collimation Possibility Determining Unit |
| 111, 411 | Control Instruction Changing Unit |
| 113, 157 | Drive Control Unit |
| 153 | Inclination Information Transmitting Unit |
| 155 | Control Instruction Receiving Unit |
| 407 | Inclination Information Receiving Unit |
| 413 | Control Instruction Transmitting Unit |
| 501 | Determining Unit |
| 503 | Changing Unit |

What is claimed is:

1. A moving body control system comprising:
a moving body with a target; and
one or more apparatuses each including a memory storing instructions and one or more processors configured to execute the instructions, wherein
the one or more apparatuses being configured to:
irradiate the target with a light wave and specifying positional information of the target based on the light wave reflected by the target;
determine whether or not positional information of the target which has moved in response to a movement control instruction for movement of the moving body can be specified, based on positional relationship between the target and the positional information specifying means, the positional relationship being predicted depending on the movement control instruction; and
change the movement control instruction based on the result of the determination.

2. The moving body control system according to claim 1, wherein the one or more apparatuses are configured to determine whether or not the light wave irradiated from the positional information specifying means falls within a collimation possible range of the target.

3. The moving body control system according to claim 1, wherein the moving body is an unmanned aircraft.

4. The moving body control system according to claim 1, wherein the one or more apparatuses are configured to change a control parameter for controlling an altitude of the moving body to change the movement control instruction.

5. The moving body control system according to claim 1, wherein one or more apparatuses are configured to change a control parameter for controlling an inclination of the moving body to change the movement control instruction.

6. A moving body control apparatus comprising:
a memory storing instructions; and
one or more processors configured to execute the instructions to:
determine whether or not positional information of a target which has moved in response to a movement control instruction can be specified based on positional relationship between the target and a positional information specifying means, the target being provided to a moving body, the movement control instruction being for moving the moving body, the positional information specifying means irradiating the target with a light wave and specifying the positional information of the target based on the light wave reflected by the target, the positional relationship being predicted depending on the movement control instruction for movement of the moving body; and
change the movement control instruction based on the result of the determination.

7. The moving body control apparatus according to claim 6, wherein the one or more processors are configured to determine whether or not the light wave irradiated from the positional information specifying means falls within a collimation possible range of the target.

8. The moving body control apparatus according to claim 6, wherein the moving body is an unmanned aircraft.

9. The moving body control apparatus according to claim 6, wherein the one or more processors are configured to change a control parameter for controlling an altitude of the moving body to change the movement control instruction.

10. The moving body control apparatus according to claim 6, wherein the one or more processors are configured to change a control parameter for controlling an inclination of the moving body to change the movement control instruction.

11. A moving body control method comprising:
determining whether or not positional information of a target which has moved in response to a movement control instruction can be specified based on positional relationship between the target and a positional information specifying means, the target being provided to a moving body, the movement control instruction being for moving the moving body, the positional information specifying means irradiating the target with a light wave and specifying the positional information of the target based on the light wave reflected by the target, the positional relationship being predicted depending on the movement control instruction; and
changing the movement control instruction based on the result of the determination.

12. The moving body control method according to claim 11, wherein the determining is determining whether or not the light wave irradiated from the positional information specifying means falls within a collimation possible range of the target.

13. The moving body control method according to claim 11, wherein the moving body is an unmanned aircraft.

14. The moving body control method according to claim 11, wherein the changing the movement control instruction includes changing a control parameter for controlling an altitude of the moving body to change the movement control instruction.

15. The moving body control method according to claim 11, wherein the changing the movement control instruction includes changing a control parameter for controlling an inclination of the moving body to change the movement control instruction.
